(19) United States
(12) Patent Application Publication
(10) Pub. No.: US 2025/0184913 A1
(43) Pub. Date: Jun. 5, 2025

(54) System and Method for Selecting Power Levels for Radio Frequency Transmissions

(71) Applicant: ZEBRA TECHNOLOGIES CORPORATION, Lincolnshire, IL (US)

(72) Inventors: Po-Tsang Lin, New Taipei City (TW); Chun-Hung Cheng, Taipei (TW); Ho-Chen Hsiao, New Taipei City (TW); Wei-Yu Mu, Taipei (TW)

(21) Appl. No.: 18/526,736

(22) Filed: Dec. 1, 2023

(51) Int. Cl. H04W 52/28; H04W 52/34

(52) U.S. Cl. CPC H04W 52/285; H04W 52/34

(57) ABSTRACT

An example method includes: obtaining input data representing a context of a computing device; determining, from the input data, an accessory context of the computing device; determining a relative anatomical location of the computing device; selecting a power level based on the accessory context and the relative anatomical location of the computing device; and instructing a radio transmitter to operate according to the selected power level.

### BACKGROUND

Mobile computing devices can include wireless communications assemblies, which generate varying levels of radio frequency (RF) radiation. Mobile computing devices may reduce the power level of RF transmissions to meet regulatory limits imposed on the Specific Absorption Rate (SAR) of RF radiation by human operators. However, power level reductions may result in reduced quality of wireless communications.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic diagram of an example system for selecting a power level for radio frequency transmissions

FIG. 2 is a block diagram of certain internal hardware components of the detection device of FIG. 1.

FIG. 3 is a flowchart of an example method of selecting a power level for radio frequency transmissions.

FIG. 4 is a flowchart of an example method of determining the accessory context at block 310 of the method of FIG. 3.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method comprising: obtaining input data representing a context of a computing device; determining, from the input data, an accessory context of the computing device; determining a relative anatomical location of the computing device; selecting a power level based on the accessory context and the relative anatomical location of the computing device; and instructing a radio transmitter to operate according to the selected power level.

Additional examples disclosed herein are directed to a device comprising: a memory configured to store a mapping between combinations of an accessory context and a relative anatomical location of the computing device and a corresponding power level for radio frequency transmission: a communications interface including a radio transmitter: a processor interconnected with the memory and the communications interface, the processor configured to: obtain input data representing a context of the computing device; determine, from the input data, the accessory context of the computing device; determine the relative anatomical location of the computing device; and select the corresponding power level based on the accessory context of the computing device and the relative anatomical location of the computing device; and instruct the radio transmitter to operate according to the selected power level.

Additional examples disclosed herein are directed to non-transitory machine-readable medium storing instructions which when executed, configure a processor of a computing device to: obtain input data representing a context of the computing device; determine, from the input data, an accessory context of the computing device; determine a relative anatomical location of the computing device; select a corresponding power level based on the accessory context and the relative anatomical location of the computing device; and instruct a radio transmitter to operate according to the selected power level.

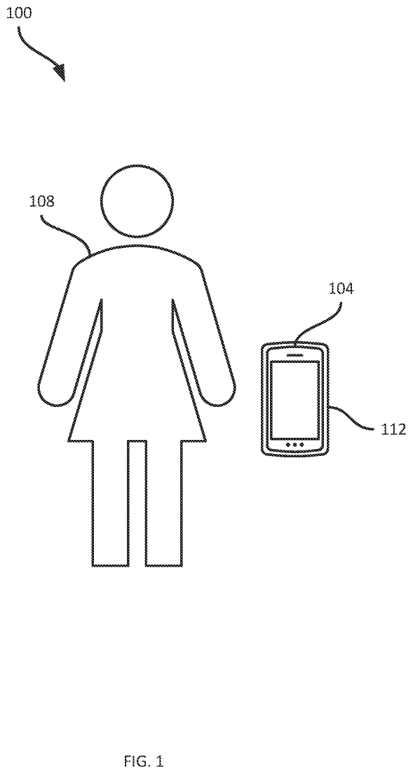

FIG. 1 depicts a system 100 for controlling radio frequency (RF) transmission power levels in accordance with the teachings of this disclosure. The system 100 includes a computing device 104 (also referred to herein as simply the device 104) which may be used by an operator 108. The device 104 may be a mobile computing device, such as a smart phone, a tablet, a portable computer, a barcode scanner, or the like. In some examples, the device 104 may be associated with an accessory 112, such as a case, a cradle or dock, a wearable mount, or the like.

In particular, the device 104 may be configured, as described below, for wireless communications which are configured, when in use, to emit radio frequency (RF) radiation. RF radiation may be harmful to humans, and hence, regulatory Specific Absorption Rate (SAR) limits may be imposed based on the region of the human body exposed to the RF radiation. Accordingly, the system 100, and more particularly, the device 104 is deployed to determine a suitable power level based on the accessory context (i.e., based on identification of the type of the accessory 112 or the lack of an accessory) and the relative anatomical location of the device 104 (i.e., the location of the device 104 relative to the operator 108). Radio transmissions may then be controlled according to the selected power level to limit RF radiation to the operator 108 to the appropriate SAR limits based on the relative anatomical location of the device 104.

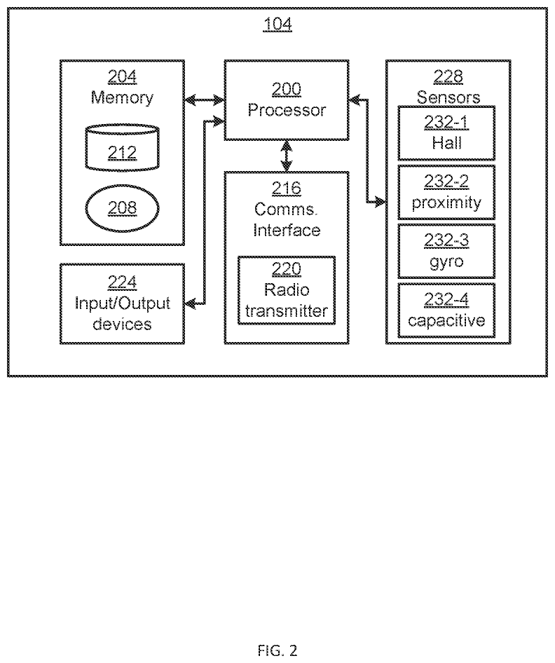

Turning now to FIG. 2, certain internal components of the computing device 104 are illustrated. The device 104 includes a processor 200 interconnected with a non-transitory computer-readable storage medium, such as a memory 204. The memory 204 includes a combination of volatile memory (e.g. Random Access Memory or RAM) and non-volatile memory (e.g. read only memory or ROM, Electrically Erasable Programmable Read Only Memory or EEPROM, flash memory). The processor 200 and the memory 204 may each comprise one or more integrated circuits.

The memory 204 stores computer-readable instructions for execution by the processor 200. In particular, the memory 204 stores an application 208 which, when executed by the processor, configures the processor 200 to perform various functions discussed below in greater detail and related to the RF transmission control operation of the device 104. The application 208 may also be implemented as a suite of distinct applications.

Those skilled in the art will appreciate that the functionality implemented by the processor 200 may also be implemented by one or more specially designed hardware and firmware components, such as a field-programmable gate array (FPGAs), application-specific integrated circuits (ASICs) and the like in other embodiments. In an embodiment, the processor 200 may be, respectively, a special purpose processor which may be implemented via dedicated logic circuitry of an ASIC, an FPGA, or the like in order to enhance the processing speed of the operations discussed herein. The memory 204 also stores a repository 212 storing rules and data for controlling RF transmissions, as will be described further herein.

The device 104 also includes a communications interface 216 enabling the device 104 to exchange data with other computing devices. The communications interface 216 is interconnected with the processor 200 and includes suitable hardware (e.g. transmitters, receivers, network interface controllers and the like) allowing the device 104 to communicate with other computing devices.

In particular, the communications interface 216 may include a radio transmitter 220 including one or more antennas, as well as suitable control hardware and firmware for transmitting and receiving data via the antennas. The antennas may be, for example, configured to communicate according to one or more suitable Wi-Fi standards, wireless wide-area network (WWAN) communications according to standards such as 4G/Long Term Evolution (LTE), 5G, or the like.

In some examples, the communications interface 216 may include a dedicated controller (e.g., a micro-controller, a micro-processor, etc.) configured to perform some or all of the RF transmission control operation in cooperation with or instead of the processor 200. Accordingly, the controller may include one or more integrated circuits and may include and/or be interconnected with a non-transitory computer-readable storage medium storing computer-readable instructions which when executed, configure the controller to perform the functionality described herein.

The device 104 may further include one or more input and/or output devices 224. The input devices 224 may include one or more buttons, keypads, touch-sensitive display screens or the like for receiving input from an operator. The output devices 224 may further include one or more display screens, sound generators, vibrators, or the like for providing output or feedback to the operator 108.

The device 104 may further include a sensor suite 228 including a plurality of sensors 232, of which four example sensors 232 are depicted. In the present example, the sensor suite 228 includes a Hall sensor 232-1, a proximity sensor 232-2 (e.g., including suitable electromagnetic, capacitive, photoelectric, etc. sensing capabilities), a gyroscopic sensor 232-3, and a capacitive sensor 232-4. In other examples, other sensors, such as audio sensors, optical sensors, and the like may also be included in the sensor suite 228.

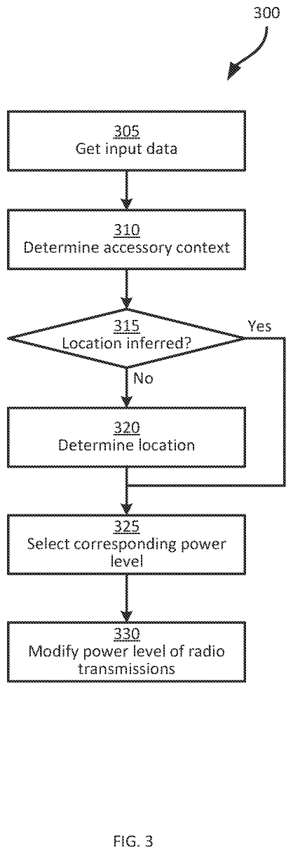

Turning now to FIG. 3, the functionality implemented by the device 104 will be discussed in greater detail. FIG. 3 illustrates a method 300 of controlling RF transmissions of a computing device. The method 300 will be discussed in conjunction with its performance in the system 100, and particularly by the device 104, via execution of the application 208. In particular, the method 300 will be described with reference to the components of FIGS. 1 and 2. In other examples, the method 300 may be performed by other suitable devices or systems.

The method 300 is initiated at block 305, where the device 104, and more particularly, the processor 200, obtains input data representing a context of the computing device 104. For example, the input data may include a set of measurements obtained from the sensor suite 228, operational parameters of the device 104, and the like. In some examples, the input data may further include data received from other devices, such as the accessory 112, for example identifying the accessory 112 or providing additional context about the environment in which the device 104 is operating. In some examples, the input data may further include data obtained at an input device 224 of the computing device, for example from an operator 108 of the device 104 or the like.

At block 310, the device 104 determines, based on a subset of the input data, an accessory context of the computing device 104. That is, the device 104 may determine whether or not the device 104 is paired with an accessory 112, and if so, a type of the accessory 112.

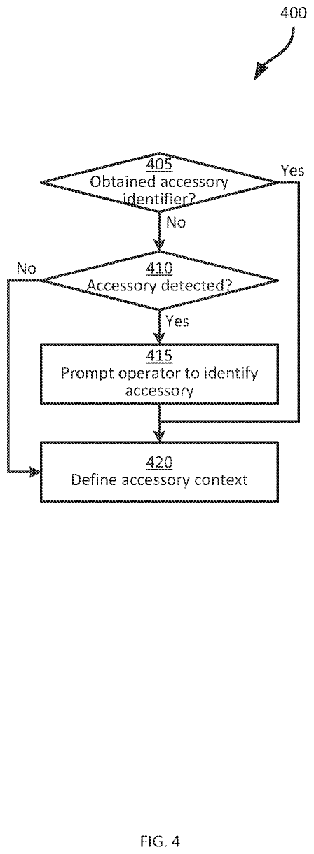

For example, referring to FIG. 4, an example method 400 of determining the accessory context of the computing device 104 is depicted.

At block 405, the device 104 determines whether an accessory identifier has been received from the accessory 112, for example, when the accessory 112 is an active accessory capable of active communications with the device 104. For example, the device 104 may obtain the accessory identifier of an active accessory 112 when the accessory 112 is initially paired with the device 104 and therefore make an affirmative determination at block 405. In other examples, the device 104 may send an active request for an accessory identifier and wait for a predetermined response time prior to making a determination at block 405. In such examples, the device 104 may receive the accessory identifier via the communications interface 216, as a response to the request for the accessory identifier.

If the determination at block 405 is affirmative, that is, the device 104 has obtained the accessory identifier from the accessory 112, then the device 104 proceeds to block 420 to define the accessory context for the device 104.

If the determination at block 405 is negative, that is, the device 104 has not obtained an accessory identifier, then the device 104 proceeds to block 410. At block 410, the device 104 determines, based on the input data or a subset of the input data, whether an accessory 112 is detected. In particular, the device 104 may use a first sensor measurement or a first subset of sensor measurements to make the determination at block 410.

For example, the device 104 may make an initial determination at block 410 based on a Hall sensor measurement from the Hall sensor 232-1. The Hall sensor measurement may represent the presence and magnitude of a magnetic field, which the device 104 may analyze to determine whether the presence of the accessory 112 is indicated. The Hall sensor measurement may be compared to a default Hall sensor value to determine whether an existing magnetic field has been interrupted, for example, via pairing of the device 104 with the accessory 112. That is, based on the Hall sensor measurement, the device 104 may determine whether it is paired with an accessory 112.

In some examples, the device 104 may additionally verify the determination made at block 410. In particular, the device 104 may obtain additional sensor measurements or an additional subset of sensor measurements to verify that presence or lack thereof of the accessory 112. For example, the device 104 may verify the presence of the accessory 112 based on a proximity sensor measurement from the proximity sensor 232-2. In particular, the proximity sensor 232-2 may be located in a region of the device 104 which is likely to be covered when the device 104 is paired with an accessory 112, such as a rear of the device 104 or a bezel of the device 104.

If the determination at block 410 is affirmative, that is, the device 104 determines that an accessory 112 is detected, then the device 104 proceeds to block 415. At block 415, in response to detecting an accessory 112, the device 104 prompts the operator 108 to identify the accessory. For example, the device 104 may provide a prompt on a display of the device 104, listing possible accessories 112 which may be paired with the device 104.

If the determination at block 410 is negative, that is, the device 104 determines that an accessory 112 is not detected, then the device 104 proceeds to directly to block 420 to define the accessory context for the device 104. In some examples, if the initial determination at block 410 and the verification contradict one another, the device 104 may identify an error condition or otherwise prompt the operator 108 to clarify the accessory context of the device 104.

At block 420, the device 104 defines the accessory context. That is, the device 104 may return an indication of whether or not the device 104 is paired with an accessory 112, as well as the identifier of the accessory, if the indication is affirmative. The device 104 may then return to block 315 of the method 300.

Returning to FIG. 3, at block 315, the device 104 determines whether a relative anatomical location of the device 104 can be inferred from the accessory context. For example, if the accessory context indicates that no accessory is paired with the device 104, then the device 104 may make a negative determination at block 315.

If the accessory context indicates that an accessory 112 is paired with the device 104, then the device 104 may be able to infer the relative anatomical location of the device 104 from the accessory context, and more particularly, from the identification of the type of accessory 112. The relative anatomical location of the device 104 is the location of the device 104 relative to the operator 108, such as near the head of the operator 108, near the body of the operator 108, near an extremity of the operator 108, or stand-alone (i.e., away from the operator 108 entirely). In other examples, other relative anatomical locations may also be defined. In particular, the relative anatomical location of the device 104 affects the regulatory SAR limits, and accordingly, the device 104 may adjust the transmission power at which the radio transmitter 220 operates based on the relative anatomical location, as will be described further herein.

In particular, some accessories 112 may allow the device 104 to infer the relative anatomical location of the device 104 based on normal operating parameters of the accessory 112. For example, if the accessory 112 is identified as a cradle or dock (e.g., a vehicular cradle, a charging cradle, or the like), then the device 104 may infer that the device 104 is operating in a stand-alone mode. In other examples, if the accessory 112 is identified as a wearable mount (e.g., a wrist mount, a hip holster, or the like), or for certain specific-use purposes (e.g., a gun-type mount), then the device 104 may infer that the relative anatomical location of the device 104 is the extremities of the operator 108 or the body of the operator 108, according to the operating parameters of the accessory 112.

Accordingly, if the device 104 is able to infer the relative anatomical location of the device 104 based on the accessory context, the device 104 may make an affirmative determination at block 315 and proceed directly to block 325.

If the determination at block 315 is negative, that is, the device 104 is not able to infer the relative anatomical location of the device 104 based on the accessory context, then the device 104 proceeds to block 320.

At block 320, the device 104 determines, based on a further subset of the input data, the relative anatomical location of the device 104. The further subset of the input data may be selected independently of the first subset of the input data used to determine the accessory context at block 310. Accordingly, the further subset of the input data may be mutually exclusive from the first subset of the input data, identical to the first subset of the input data, or have some overlapping and some non-overlapping data points.

For example, the device 104 may determine the relative anatomical location of the device 104 based on operating parameters of the device 104, such as audio path data defining an audio path used by the device 104. If the device 104 is configured to deliver audio through a receiver of the device 104, then the device 104 may determine that the relative anatomical location is near the head of the operator 108, since the device 104 would be placed proximate the operator's ear for the operator 108 to hear the audio being delivered. If the device 104 is configured to deliver audio through a speaker or other connected audio device (e.g., headphones connected via a wired or wireless connection), then the relative anatomical location may be at the extremities of the user (e.g., handheld), stand-alone, or near the body of the user (e.g., in a pocket).

Accordingly, the device 104 may further obtain gyroscopic measurements (i.e., motion data) from the gyroscopic sensor 232-3. In particular, the gyroscopic sensor 232-3 may measure movement along the x-, y-, and z-axes in three-dimensional space. The device 104 may then compute the speed (i.e., as calculated based on a difference between a current measurement and a previous measurement over time) or acceleration of movement along any of the axes. If the computed speed, and in particular, the overall speed of the device 104 as combined from the speed in each of the three axes, is above a predefined threshold, then the device 104 may determine that it is in motion, and is likely being held or otherwise carried by the operator 108. If the computed speed is below the predefined threshold, and has remained below the predefined threshold for at least a predefined amount of time (e.g., 30 seconds, 1 minute, etc.), then the device 104 may determine that the device 104 is stand-alone and away from the operator.

If the computed speed is above the predefined threshold, the device 104 may obtain a proximity sensor measurement from the proximity sensor 232-2, a capacitance measurement from the capacitive sensor 232-4, or the like to assist in differentiating between the device 104 being located near the body or the extremities of the operator 108. For example, the proximity sensor 232-2 may be located on the device 104 at a location that is unlikely to be covered by the hands of the operator 108 when in use. Accordingly, if the proximity sensor measurement indicates a nearby object, the device 104 may assume that the nearby object is a holster and/or an article of clothing of the operator 108, and accordingly, may infer that the relative anatomical location of the device 104 is the body of the operator 108.

Similarly, the capacitive sensor 232-4 may be located on the device 104 at a location that is likely to be handled by the operator 108 when in use. Accordingly, if the capacitance measurements indicate handling by the operator, the device 104 may infer that the relative anatomical location of the device 104 is the extremities of the operator 108.

In other examples, other input data, or combinations of input data may also be used to infer the relative anatomical location of the device 104. For example, if the accessory 112 is a lanyard, and the device 104 is not determined to be held in the hand (e.g., by the capacitive sensor 232-4), in a pocket or holster (e.g., by the proximity sensor 232-2), stand-alone away from the operator 108 (e.g., by the gyroscopic sensor 232-1), then the device 104 may determine that the device 104 is hanging on the lanyard, and hence may infer that the relative anatomical location of the device 104 is the body of the operator 108.

In some examples, combinations of the above and additional input data may also be used to cross-check and verify that the determined relative anatomical location does not violate any determinations based on a different subset of the input data.

After determining the relative anatomical location of the device 104, the device 104 proceeds to block 325 to select a suitable power level for RF transmissions based on the accessory context and the relative anatomical location of the device 104. For example, the device 104 may store, in the repository 212, a mapping between combinations of the accessory context and the relative anatomical location of the device 104 and a corresponding power level for RF transmission which result in an SAR for the operator 108 which are within the regulatory limits.

In particular, the corresponding power levels may be defined based on the regulatory SAR limits for the relative anatomical location, and may be modified based on specific features of the accessory context, and more particularly, the accessory 112 paired with the device 104. For example, certain accessories 112, such as gun-type accessories 112 may have certain physical dimensions or use parameters which result in a further distance of the device 104 from the relative anatomical location (i.e., the body or extremities, etc.) of the device 104. Accordingly, the power levels may be modified to be moderately increased based on the expected reduction in SAR during normal use of the accessory 112. Similarly, some accessories 112 may include electromagnetic blocking or shielding features which may reduce the expected SAR at the relative anatomical location. Accordingly, the corresponding power levels for the specific accessory context may be modified to be moderately increased based on the expected reduction in SAR from the specific physical features of the accessory 112.

In some examples, in addition to the accessory context and the relative anatomical location of the device 104, certain operating parameters of the device 104 may also be cross-referenced for selecting and/or modifying the power level for RF transmissions. For example, if the device 104 detects that the display of the device 104 is off, then the device 104 may be operating in a power-saving mode, and hence scanning rate may be reduced. Accordingly, as the SAR is computed over time, power levels for RF transmissions may be moderately increased due to the reduction in scanning frequency. Similarly, if the device 104 detects that the device 104 is operating in a hot-spot mode, the device 104 may be operating at a higher transmission frequency to enable other computing devices to connect to the device 104. Accordingly, the power levels for RF transmission may be moderately reduced.

In other examples, other operating parameters or environmental context factors may also contribute to the selection or modification of different power levels for RF transmission.

At block 330, device 104 controls the radio transmitter 220 to operate according to the selected power level. Accordingly, the device 104 may be configured to operate such that the radiation received by the operator 108 is within the regulatory SAR limits, while also operating at a higher power level, where possible, to increase performance of the device 104.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method comprising:
obtaining input data representing a context of a computing device;
determining, from the input data, an accessory context of the computing device;
determining a relative anatomical location of the computing device;
selecting a power level based on the accessory context and the relative anatomical location of the computing device; and
instructing a radio transmitter to operate according to the selected power level.

2. The method of claim 1, wherein determining the relative anatomical location comprises inferring the relative anatomical location from the accessory context.

3. The method of claim 1, further comprising, when the relative anatomical location cannot be inferred from the accessory context, determining the relative anatomical location based on one or more of:
audio path data of the computing device;
gyroscopic measurements from a gyroscopic sensor of the computing device;
capacitance measurements from a capacitive sensor of the computing device; and
proximity sensor measurements from a proximity sensor of the computing device.

4. The method of claim 3, wherein determining the relative anatomical location based on gyroscopic measurements comprises:
obtaining respective movement measurements along x-, y- and z-axes;
computing a respective speed along each of the x-, y- and z-axes;
computing an overall speed of the computing device by combining the respective speed along each of the x-, y- and z-axes; and
when the overall speed of the computing device is below a predefined threshold, determining that the relative anatomical location is stand-alone from an operator.

5. The method of claim 1, wherein the input data comprises one or more of:
an accessory identifier received from an accessory paired with the computing device;
a magnetic field measurement from a Hall sensor;
a proximity sensor measurement from a proximity sensor; and
user input identifying a type of accessory.

6. The method of claim 1, wherein selecting the power level comprises defining the power level based on the relative anatomical location and modifying the power level based on the accessory context.

7. A computing device comprising:
a memory configured to store a power level for radio frequency transmission, the power level corresponding to a mapping between an accessory context of the computing device and a relative anatomical location of the computing device;
a communications interface including a radio transmitter;
a processor interconnected with the memory and the communications interface, the processor configured to:
obtain input data representing a context of the computing device;
determine, from the input data, the accessory context of the computing device;
determine the relative anatomical location of the computing device;
select the power level based on the accessory context of the computing device and the relative anatomical location of the computing device; and
instruct the radio transmitter to operate according to the selected power level.

8. The computing device of claim 7, wherein, to determine the relative anatomical location, the processor is configured to infer the relative anatomical location from the accessory context.

9. The computing device of claim 7, wherein, when the relative anatomical location cannot be inferred from the accessory context, the processor is configured to determine the relative anatomical location based on one or more of:
audio path data of the computing device;
gyroscopic measurements from a gyroscopic sensor of the computing device;
capacitance measurements from a capacitive sensor of the computing device; and
proximity sensor measurements from a proximity sensor of the computing device.

10. The computing device of claim 9, wherein to determine the relative anatomical location based on gyroscopic measurements, the processor is configured to:
obtain respective movement measurements along x-, y- and z-axes;
compute a respective speed along each of the x-, y- and z-axes;
compute an overall speed of the computing device by combining the respective speed along each of the x-, y- and z-axes; and
when the overall speed of the computing device is below a predefined threshold, determine that the relative anatomical location is stand-alone from an operator.

9. The computing device of claim 7, wherein the input data comprises one or more of:
an accessory identifier received from an accessory paired with the computing device;
a magnetic field measurement from a Hall sensor;
a proximity sensor measurement from a proximity sensor; and
user input identifying a type of accessory.

12. The computing device of claim 7, wherein to select the power level, the processor is configured to define the power level based on the relative anatomical location and modify the power level based on the accessory context.

13. A non-transitory machine-readable medium storing instructions which when executed, configure a processor of a computing device to:
obtain input data representing a context of the computing device;
determine, from the input data, an accessory context of the computing device;
determine a relative anatomical location of the computing device;
select a corresponding power level based on the accessory context and the relative anatomical location of the computing device; and
instruct a radio transmitter to operate according to the selected power level.

14. The non-transitory machine-readable medium of claim 13, wherein, to determine the relative anatomical location, the instructions further configure the processor to infer the relative anatomical location from the accessory context.

15. The non-transitory machine-readable medium of claim 13, wherein when the relative anatomical location cannot be inferred from the accessory context, the instructions configure the processor to determine the relative anatomical location based on one or more of:
audio path data of the computing device;
gyroscopic measurements from a gyroscopic sensor of the computing device;
capacitance measurements from a capacitive sensor of the computing device; and
proximity sensor measurements from a proximity sensor of the computing device.

16. The non-transitory machine-readable medium of claim 15, wherein to determine the relative anatomical location based on the gyroscopic measurements, the instructions configure the processor to:
obtain respective movement measurements along x-, y- and z-axes;
compute a respective speed along each of the x-, y- and z-axes;
compute an overall speed of the computing device by combining the respective speed along each of the x-, y- and z-axes; and
when the overall speed of the computing device is below a predefined threshold, determine that the relative anatomical location is stand-alone from an operator.

17. The non-transitory machine-readable medium of claim 13, wherein the input data comprises one or more of:
an accessory identifier received from an accessory paired with the computing device;
a magnetic field measurement from a Hall sensor;
a proximity sensor measurement from a proximity sensor; and
user input identifying a type of accessory.

18. The non-transitory machine-readable medium of claim 13, wherein to select the power level, the instructions further configure the processor to define the power level based on the relative anatomical location and modifying the power level based on the accessory context.
